(19) United States
(12) Patent Application Publication
(10) Pub. No.: US 2009/0326999 A1
(43) Pub. Date: Dec. 31, 2009

(54) INNOVATION DEVELOPMENT TRACKING AND MANAGEMENT

(75) Inventor: Michael Thomas Duke, Monroe, NC (US)

Correspondence Address: TUROCY & WATSON, LLP, 127 Public Square, 57th Floor, Key Tower, CLEVELAND, OH, 44114, US

(73) Assignee: WACHOVIA CORPORATION, Charlotte, NC (US)

(21) Appl. No.: 12/164,578

(22) Filed: Jun. 30, 2008

(51) Int. Cl. G06Q 10/00; G06N 5/02; G06F 3/048

(52) U.S. Cl. 705/7; 705/1; 706/46; 715/772

(57) ABSTRACT

Systems (and corresponding methodologies) for monitoring and tracking the evolution of innovations within organizations, such as corporations, are provided. The innovation employs an image rendering to graphically convey development status. Overall, the innovation discloses a formalized mechanism by which innovations can be progressed from conception to product (or process) development and deployment. Thus, the innovation structures the evolution process of ideas throughout the development from conception to application.

### BACKGROUND

Intellectual property (IP) (e.g., innovations, patents, trademarks) is sometimes referred to as capital upon which companies can distinguish themselves from their competitors. Oftentimes, IP provides companies a competitive edge over and above their competition. While procurement, maintenance and enforcement of IP, for example patents, is an increasing popular mechanism for digital age technology companies to gain a competitive edge, today, companies (and individuals) in most every segment of business are securing IP rights to protect and enforce novel ideas. For instance, the value of IP for the largest United States companies has been estimated between 45% and 75% of the total value of these companies. As can be expected, this is one of the highest growth segments in the global economy in recent times.

A common manner by which to calculate the value of IP is to consider the return on investment (ROI) related to the research, development and testing of new ideas. Many enterprises consider an acceptable ROI as one that enables company growth as well as continued funding to further develop innovations. While IP has become a major focus related to competitive advantage for companies, today, companies are struggling with mechanisms by which to efficiently evolve the idea into a marketable product or service.

In one example, case study analysis of software systems (e.g., ecommerce) has proven to be extremely useful to development requirements and to the design of such systems. Today, when developing a software application, it is oftentimes difficult to predict how the application will react or otherwise operate under real-world conditions. In other words, it is difficult, if not impossible, to predict every usage scenario of an application prior to and during development and/or before completion. Frequently, upon completion, a developer will have to modify the application in order to adhere to real-world conditions. This modification can consume many hours of programming time and delay application deployment—each of which is very expensive.

In accordance with traditional innovation life cycle development, it is currently not possible to proactively (and accurately) predict usage scenarios and marketability from conception to development within the life cycle. For instance, in the case of software development, developers often find themselves addressing issues such as security and performance after the fact—after development is complete. This retroactive modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methodologies) for monitoring and tracking the evolution of innovations within organizations, such as corporations. In one aspect, the innovation employs a rendering of a bridge to graphically convey development status, aka ‘bridge process.’ Overall, the innovation discloses a formalized mechanism by which innovations can be progressed from conception to product (or process) development and deployment.

Essentially, the innovation enables evolution tracking and monitoring from the beginning stages of an idea, through planning, beta testing and subsequently deployment. In one aspect, the innovation can be analogized to an onion where the outer layer of the onion comprises four general phases or stages. Peeling the onion further defines these phases and solicits information and involvement from key members of a development team. In a particular aspect, the four phases comprise focusing on the inventor, focusing on the idea, focusing on the company and finally, focusing on the customer. Each of the phases include thresholds or ‘gates’ by which a project can be rated. In the event a threshold is not met, oftentimes, an idea will be ‘shelved’ or set aside until enough information or support is available to justify progression to the next stage.

The stages or phases effectuate or otherwise facilitate a multi-lateral decisioning process that solicits involvement from disparate individuals or groups. This solicitation inherently exposes the idea to many aspects of the organization, for example, business leaders, technology leaders, external partners, etc. A steering committee can be comprised of a subset of these individuals thereby enabling an effective analysis to determine if the innovation should proceed to the next phase of the evolution.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a block diagram of an example system that facilitates evolution tracking of an innovation in accordance with an aspect of the disclosure.

FIG. 2 illustrates an example block diagram of a four phase evolution development system in accordance with an aspect of the disclosure.

FIG. 3 illustrates an example flow chart of procedures that facilitate comprehensive innovation development in accordance with an aspect of the innovation.

FIG. 4 illustrates an alternative block diagram of an example system that facilitates innovation tracking in accordance with an aspect of the disclosure.

FIG. 5 illustrates an example block diagram of an analyzer component in accordance with an aspect of the disclosure.

FIG. 6 illustrates an alternative example block diagram of an analyzer component in accordance with an aspect of the disclosure.

FIG. 7 illustrates an example innovation dashboard in accordance with aspects of the disclosure.

FIG. 8 illustrates an example innovation tracking sheet in accordance with an aspect.

FIG. 9 illustrates an example innovation pipeline that identifies key members in accordance with aspects of the disclosure.

FIG. 10 illustrates an example bridge construction status dashboard report in accordance with an aspect.

FIG. 11 illustrates an example storyboard progression in accordance with an aspect of the disclosure.

FIG. 12 illustrates an example system that employs a user interface to gather data and/or display status in accordance with aspects.

FIG. 13 illustrates a block diagram of a computer operable to execute the disclosed architecture.

FIG. 14 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

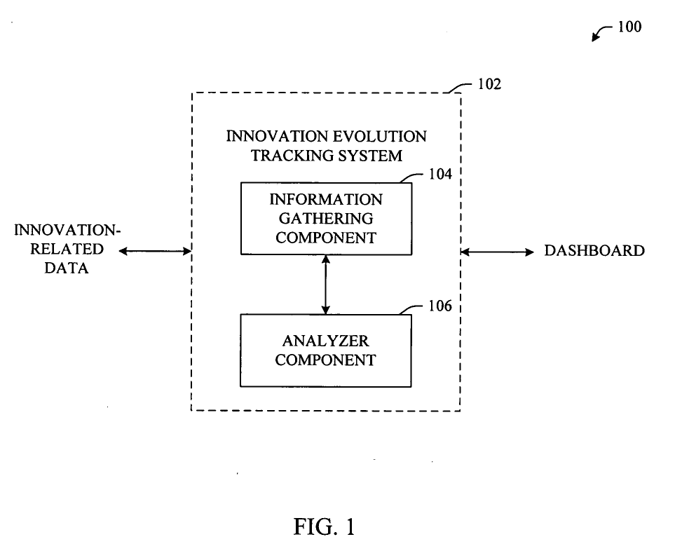

Referring initially to the drawings, FIG. 1 illustrates a system 100 that facilitates tracking the evolution of an innovation, for example, within a company, enterprise or organization. In many instances, innovations are not sponsored by a champion in order to ensure keeping the project on track. Rather, more often than not, ideas and projects fade away and never mature into products or processes as the case may be. Thus, return on investment (ROI) is compromised and idea-related revenue is lost.

As shown, system 100 includes an innovation evolution tracking system 102 that is capable of driving innovation-related ideas throughout the development progress. As illustrated, the tracking system 102 employs a dashboard to convey status of one (or more) ideas. While example status mechanisms and screen shots are illustrated, it is to be understood that most any mechanism and/or graphic as desired can be employed to display status without departing from the scope of this innovation. Accordingly, these alternative aspects are to be included within the scope of the innovation and claims appended hereto.

The tracking system 102 can include an information gathering component 104 and an analyzer component 106. Together, these sub-components (102, 104) facilitate engaging relevant individuals and accessing appropriate stores for information which can be evaluated in view of a project scope, type, benefits, potential, etc. This raw, as well as manipulated, information can be presented to an entity, for example, via a dashboard. Thus, projects and their status are maintained visible thereby decreasing probability of fading away and increasing the ability to establish meaningful and valuable innovations.

Returning to the onion analogy above, the information gathering component 104 is capable of presenting issues (e.g., questions) to an entity in order to facilitate development and assessment of an innovation. As will be understood upon a review of the figures that follow, within each phase of the evolution process, the innovation is capable of capturing information related to issues and questions from strategically selected or appropriate individuals. Decision logic can be employed to automatically present follow-up issues and questions as a function of information provided by the individuals.

The analyzer component 106 can be employed to evaluate information and instruct the information gathering component 104 related to subjects, information, issues or the like. In aspects, the analyzer component 106 can include preprogrammed rules (or implementation schemes), artificial intelligence (AI), machine learning & reasoning (MLR), or combinations thereof.

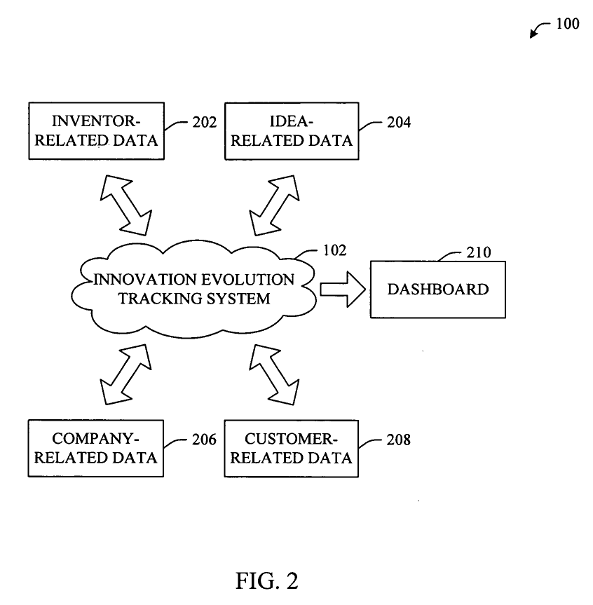

Referring now to FIG. 2, an illustration of a four-stage innovation tracking system 100 is shown. Essentially, the graphic of FIG. 2 illustrates that innovation evolution tracking system 102 processes data and information from at least four key stages (or phases). While many of the examples illustrated and discussed herein propose sequential processing of the phases, it is to be understood that, in alternative aspects, information can be gathered and processed in parallel with disparate phases. However, as described herein, in aspects, the innovation proposes that a gate or threshold must be satisfied at the end of each phase in order to proceed to the next.

The determination of success within a phase can be made on behalf of a user/entity, e.g., via rules-based mechanisms, AI, MLR, or the like. Alternatively and/or additionally, decisions can be made by a steering (or executive, management) committee whereby, the committee can be comprised of experts related to the scope, goal, or purpose of the phase.

In the exemplary tracking system 102, data is captured in four distinct phases (202, 204, 206 208). It is to be understood that each phase in an evolution tracking system can employ common users/entities to gather information and to make decisions. While there can most often be a core steering committee, the committee can be supplemented by subject-matter experts thereby increasing effectiveness of the evolution development process.

Inventor-related data 202 can be captured by way of tailored questions which drill into specific inventor-related topics. Here, the dashboard 210 can be used to present the information to a user/entity. In other aspects, the dashboard can be used by the user/entity to input information by way of customized user interface (UI) mechanisms.

Similarly, idea-related data 204, company-related (or market-ability) data 206 and customer-related (or feasibility) data 208 can be captured as the evolution progresses. It is to be understood that the company-related data 206 can refer to the question of how the innovation fits within a particular entity/company structure. The customer-related data 208 focuses upon proving the idea based upon working models that illustrate value added features, functions and benefits (e.g., competitive edge) to customers. Essentially, the system 100 provides a formalized mechanism by which ideas can progress from conception to production/deployment.

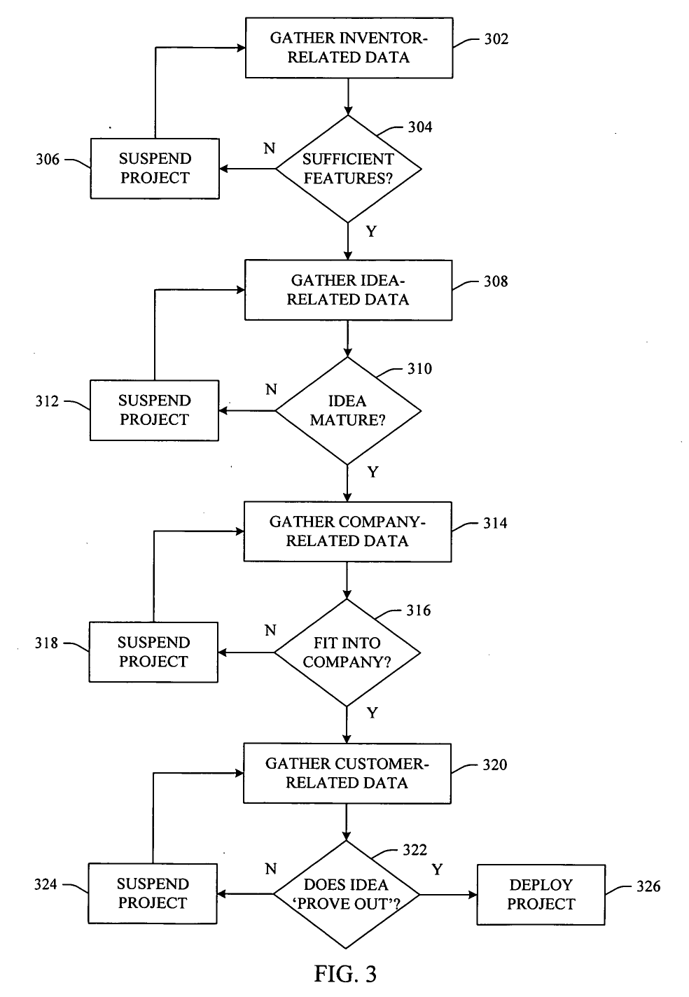

FIG. 3 illustrates a methodology of managing the evolution of an innovation in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Beginning at 302, inventor-related data is gathered. For example, questions can be presented that focus on identification, availability, and willingness of inventors to participate in the evolution or development of an idea as well as sufficiency of quality and/or quantity of features and functions. A decision is made at 304 to determine if there is sufficient quantity and quality of described features and functions. If not, the project is suspended at 306 where additional parties and/or entities can be identified. As described supra, this screening process can be effected by way of drilling into a decision tree (or hierarchy) of questions and/or issues.

At 308, idea-related data is gathered. As above, questions can be presented to appropriate individuals to establish information related to the state of the idea. Additionally, other idea-related data can be captured or formulated in an effort to further establish the state of the idea. For instance, a ‘story-board’ of the idea can be formulated which illustrates a timeline of idea evolution. For example, the present, short-term future and long-term future can be structured to illustrate an evolution of an idea.

A decision is made at 310 to determine if the idea is mature enough to pursue, for example, based upon a threshold, preference, industry standard, company policy or the like. If deemed not mature or developed enough to pursue, the project is suspended at 312. On the other hand, company related data is gathered at 308.

More particularly, at 314, the tracking mechanism turns focus onto the company. Here, the process can evaluate factors, including but not limited to, strengths, weaknesses, opportunities, market viability, etc. A determination is made at 316 to decide if the project fits into the company's structure. If not, the project is suspended at 318. Otherwise, the gate is satisfied and the process proceeds to the next stage.

In an example final phase, at 320, customer-related data is gathered. For instance, information is gathered to determine the business value add, if any. Here, road shows can be planned, beta tests implemented, etc. Essentially, this phase is used to determine if there is a marketable value to the idea or innovation. At 322, a determination is made to decide if the idea ‘proves out,’ for example, based upon a policy, preference, threshold, inference, or the like.

If the idea does not ‘prove out’ or deemed to add value, the project is suspended at 324, for example, until the market matures enough to justify the innovation, etc. On the other hand, if the project does ‘prove out,’ at 326 the project is deployed. In one aspect, a pilot is run and the product (or process) is handed off to an appropriate line of business (LOB) within the organization.

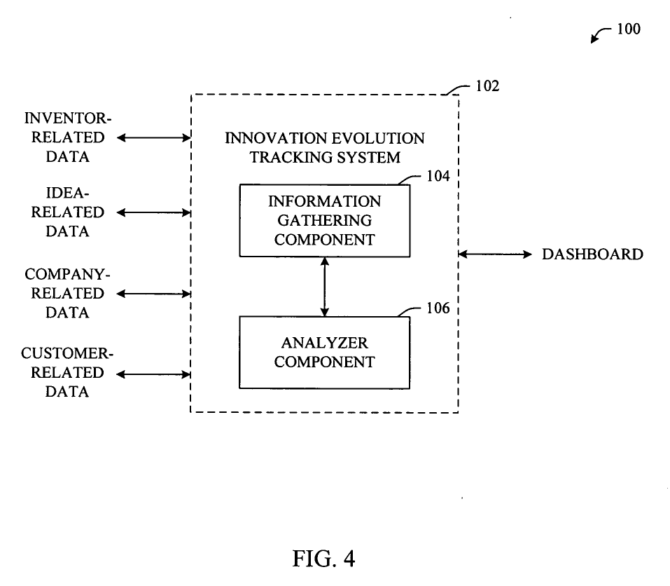

FIG. 4 illustrates an alternative block diagram of an example system 100 in accordance with an aspect of the innovation. Essentially, FIG. 4 illustrates that, in the four-stage exemplary system, the innovation evolution tracking system 102 can be employed process inventor-, idea-, company- and customer-related data in respective or otherwise sequential phases. In general, FIG. 4 illustrates that the tracking system 102 can employ an information gathering component 104 and an analyzer component 106 to process information in order to establish feasibility, viability and marketability of an idea or innovation. Thus, the system 100 establishes a comprehensive and formalized process to advance an idea from conception into a marketable product or process.

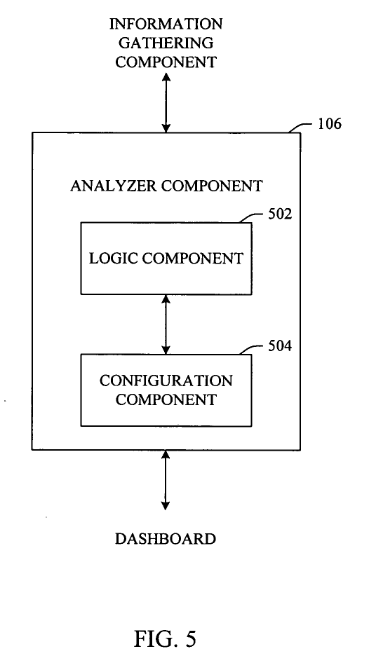

FIG. 5 illustrates an example analyzer component 106 in accordance with an aspect of the innovation. Generally, the analyzer component 106 can include a logic component 502 and a configuration component 504. Together, these sub-components facilitate comprehensive (and intelligent) monitoring by an entity of status or viability of an innovation.

As described above, the analyzer component 106 effects systematic evolution tracking with respect to an innovation. In other words, the innovation provides a process conducive to corporation or other entity environments. The innovation transcends most any concept from ideation through to implementation. In one aspect, a “bridge process,” as it's been coined, is a four-phased process that aligns with corporate internal processes and businesses. As described above, Phase 1 focuses on the inventor, Phase 2 focuses on the idea (e.g., storyboarding), Phase 3 focuses on the question “Does it fit for the corporation?” or otherwise focuses on the company, and Phase 4 “proves out” the idea through working models that represent the business value add, for example, by focusing on the customer and/or market.

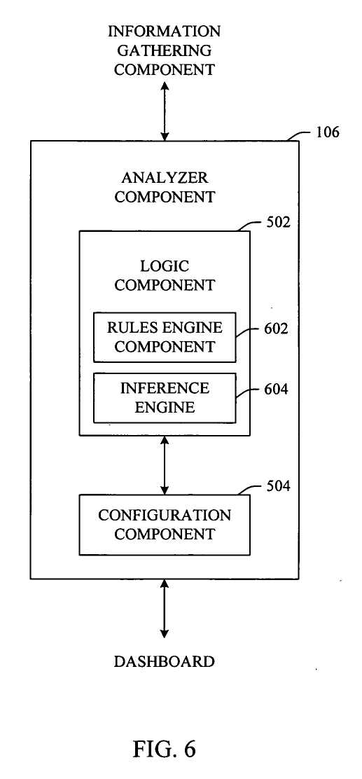

FIG. 6 illustrates yet another alternative example block diagram of an analyzer component 502. As shown, the logic component 502 can include a rules engine component 602 and an inference engine 604.

The rules engine component 602 can be employed to generate and implement procedures on behalf of a user or entity. In one aspect, the aforementioned decisioning related to transcending or moving to a subsequent phase effected by way of a rules-based mechanism. Here, these rules (e.g., thresholds, benchmarks, Boolean operators) can be explicitly or implicitly generated for or on behalf of a user.

In accordance with this alternate aspect, an implementation scheme (e.g., rule) can be applied to effect approval decisions. In response thereto, the rule-based implementation can establish decisions based upon most any desired criteria (e.g., idea-related data, inventor-related data, company-related data, customer-related data, innovation type(s), market conditions . . . ).

Similarly, the inference engine component 604 can facilitate automating one or more features in accordance with the subject innovation. The subject innovation (e.g., in connection with transferring to a subsequent phase) can employ various AI- or MLR-based schemes for carrying out various aspects thereof. For example, a process for determining when to commence a next phase in the evolution can be facilitated via an automatic classifier system and process, for example, in view of accessible data.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to commence a phase, conclude a phase, suspend a phase, etc. related to the evolution of an innovation or idea.

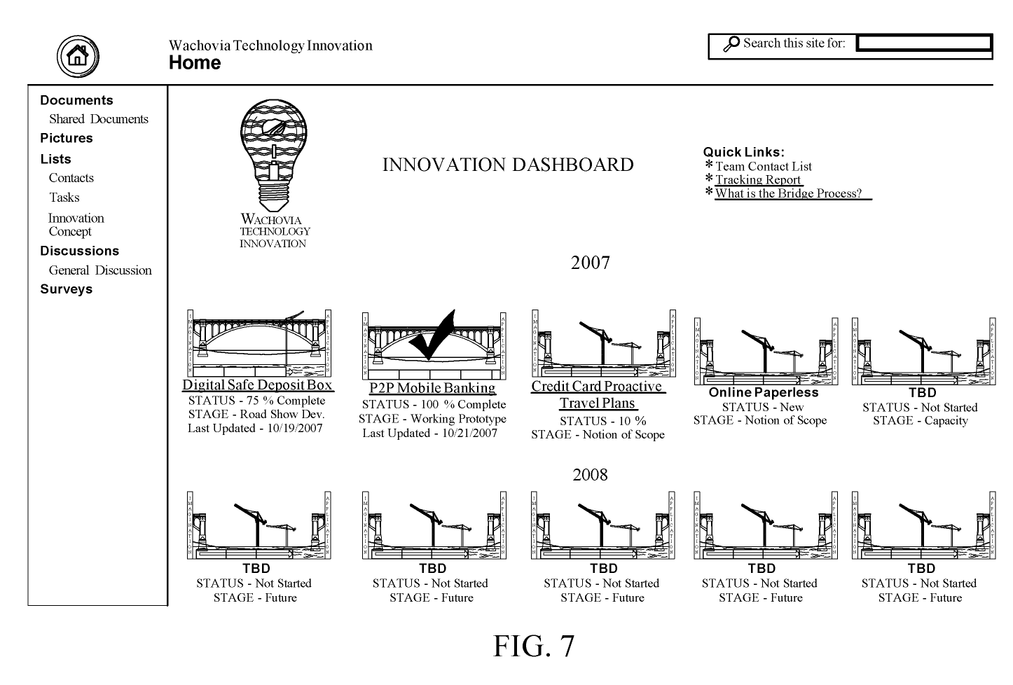

Turning now to FIG. 7, an example of an innovation dashboard is shown. While a specific page or screen shot is illustrated, it is to be understood that other aspects exist without departing from the spirit and/or scope of the innovation. As such, these alternative aspects are to be included within the scope of the innovation and claims appended hereto.

As shown, the dashboard of FIG. 7 employs a graphic of a bridge construction to cleverly convey state of the evolution of an idea. For instance, the Digital Safe Deposit Box innovation is shown as being 75% complete. This completion state is conveyed in a number of manners. First, the graphic of the bridge is 75% complete such that a crane is included to complete the small remaining portion. Next, a progress bar is illustrated that conveys three of the four segments being complete. Finally, the Status is indicated textually as 75% complete. It will be understood that most any graphic can be employed to illustrate progress of an innovation, project or idea upon a dashboard.

With continued reference to FIG. 7, it will be noted that the P2P Mobile Banking project is completed. In other words, this project is completed. In addition to a full bar, complete bridge and 100% textual indication, the dashboard can also include a check-mark to make detection of completed projects a glance-able event. Other projects can be listed and similarly, their status shown on the dashboard.

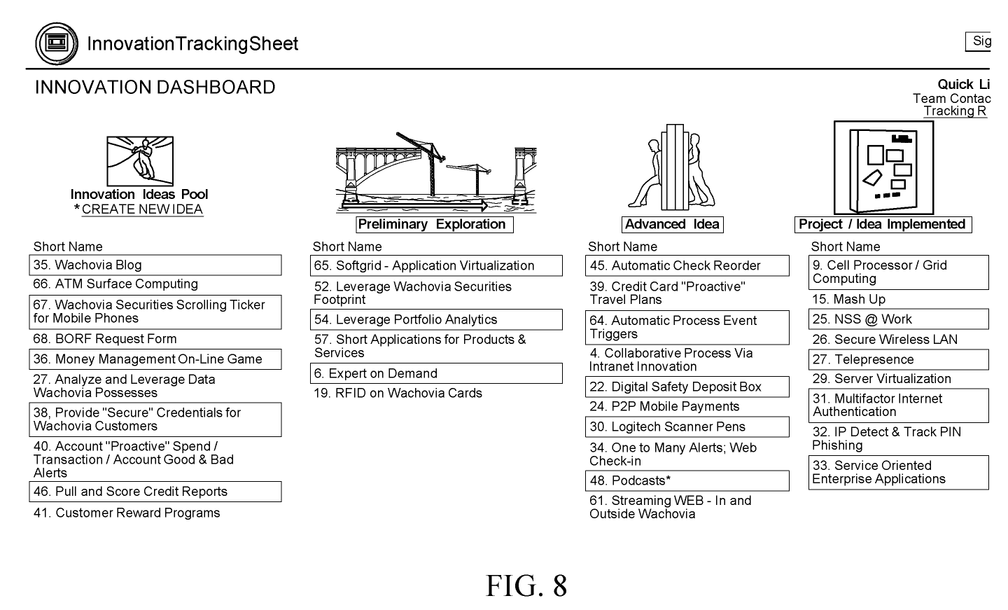

FIG. 8 illustrates yet another tracking mechanism, an innovation tracking sheet. Here, this tracking mechanism can convey status of projects throughout an enterprise, for example, from disparate departments, divisions, subsidiaries, etc. Again, as described above, while specific graphics have been chosen and used to convey project status, it is to be understood that most any graphic or indicia can be used to convey a status category without departing from the spirit and scope of this disclosure and claims appended hereto.

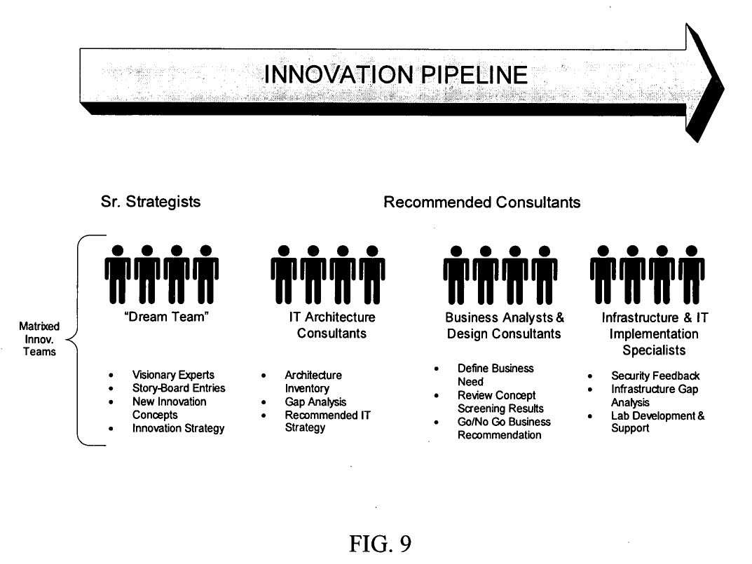

Referring now to FIG. 9, a graphical representation of an innovation pipeline in accordance with aspects of the specification is shown. As indicated, FIG. 9 illustrates example matrixed innovation teams that range from senior strategists to recommended consultants. At the beginning of the pipeline, a team of senior strategists can be convened to review the idea and to ultimately decide if a project should be pursued, abandoned or shelved.

The senior strategists are sometimes referred to as a ‘dream team’ and are part of the steering committee. This group in compiled of visionary experts from most any LOB as well as department (e.g., Business, Technology, Engineering, Marketing). Generally, these folks are responsible for story-boarding an idea, innovating and establishing new concepts, etc. Essentially, this part of the pipeline is where innovation strategy takes place.

Next in the pipeline are the Information Technology (IT) architecture consultants. This group is responsible for architecture inventory, gap analysis and overall IT strategy.

The business analysts and design consultants define the business need, review concepts and screening results. Essentially, this group offers a go, no-go business recommendation related to an innovation or proposed idea.

The infrastructure and IT implementation specialists are brought into the pipeline once a decision has been made to pursue an idea. In other words, one the previous groups have cleared an idea for production, this group becomes involved in the evolution or development. Here, this group attends to security feedback, infrastructure gap analysis as well as laboratory development and support.

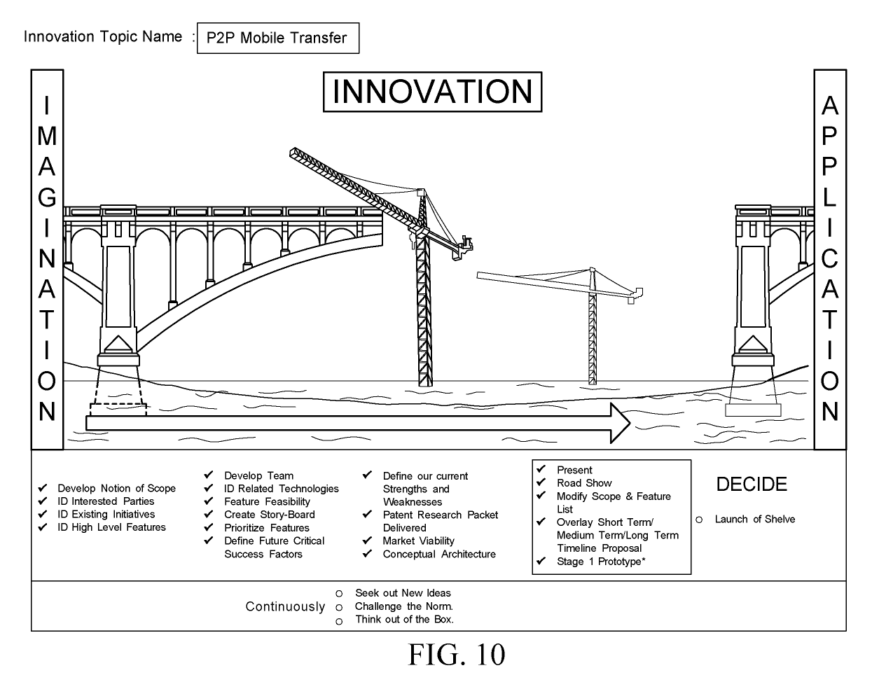

FIG. 10 represents the high level milestones for an example 16 week process. Each column represents 4 weeks worth of research or a phase. Research points are accessible by clicking (or selecting) on any one of the bridge status images.

Returning to a discussion of the exemplary four phase bridge process. As explained above, the four step process describes an innovation evolution cycle. A determination is made upon the conclusion of each phase to determine if the next phase should be commences or if the innovation should otherwise be abandoned, delayed, shelved, suspended, etc. In one example, the four phase bridge process can be described as a sixteen week bridge process where each phase is given four weeks to complete. It will be understood that, in addition to the structured format of the process, the time restriction can further enhance an ability to keep a project on track thereby enhancing production, ROI and likelihood of successful completion.

As described in greater detail supra, a bridge graphic can be employed to illustrate progress within the evolution pipeline or timeline. In this example, the pipeline progresses from left to right, e.g., from imagination to application. The lower portion of the graphical pipeline illustrates the four phases described earlier, e.g., focus on the inventor, idea, company and customer respectively from left to right. Moreover, it is to be understood that these categories are exemplary and are not intended to limit the scope of the innovation and/or claims in any manner.

In phase one, the team, or steering committee, can focus upon the inventor(s) by developing the notion of the scope of the innovation. Here, interested parties, existing initiatives and high level features can be identified. Accordingly, the inventors can be identified and a determination can be made if participation is available. If it is deemed that enough interested parties are available and interested, the pipeline can continue to phase two.

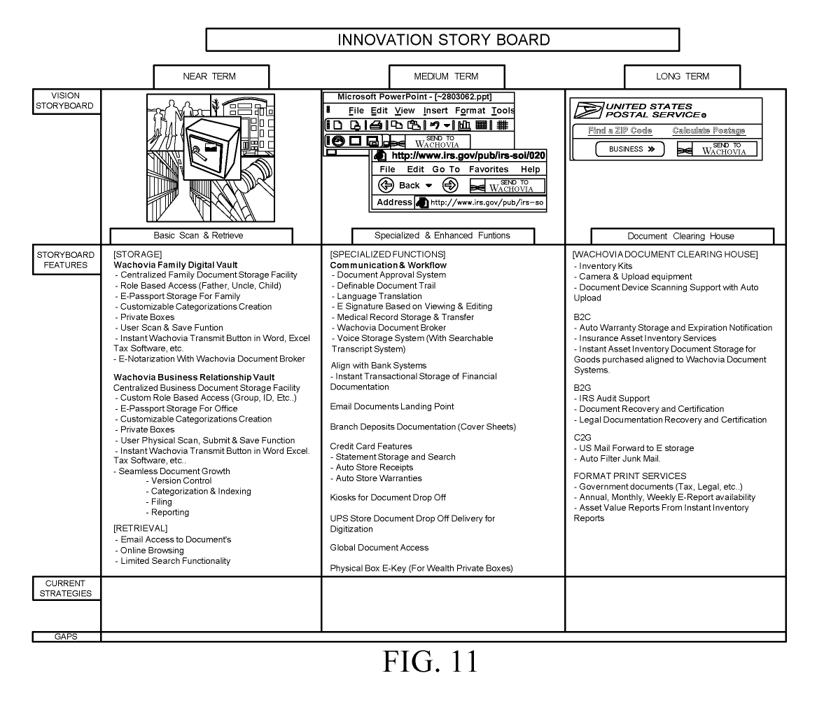

At phase two, the focus can shift to the idea. Here, a project team can be constructed to include individuals from multiple aspects and departments within a corporation. For instance, business leaders, technology experts, external consultants and partners, etc. can be assembled into a team. Related technologies can be identified and feature feasibility can be discussed and evaluated. Within this phase, a project specific story-board can be constructed that illustrates the idea in the near term, medium term and long term. FIG. 11 illustrates an example story-board in accordance with an aspect of the innovation. As will be understood, the near term describes the current state of the innovation and feasibility given current technology, budgets, manpower, etc.

The medium term is illustrative of an expanded vision for the project. Many times the medium term presumes better technology, e.g., better processors, higher bandwidths, etc. As shown, the medium term can include specialized and enhanced functionality that sometimes requires additional programming/development, funding or the like.

The long term is illustrative of the ‘wish list’ or end goal of an innovation. Here, this term is illustrative of a desired functionality set associated with the core technology. Oftentimes, the long term view presumes unlimited budget, bandwidth, processing power, memory, manpower, etc. In other aspects, the long term is merely an evolutionary progression of incorporating the idea/innovation into other aspects, LOBs, products, processes, etc. Essentially, the innovation story-board is capable of capturing the evolution of technology in a timeline manner

While the story-board of FIG. 11 includes three terms, it is to be understood that other examples exist that structure the innovation ‘story’ in different manners. These examples are to be included within the scope of this innovation and claims appended hereto.

Returning again to FIG. 10, and continuing with a discussion of the second phase which focuses on the idea, features can be prioritized, for example, in story-board form. Future critical success factors can be defined. These factors, together with other idea-related data can be instrumental in determining whether or not to proceed to the third phase which focuses on the company.

In the third phase, the information captured is instrumental in evaluating if the idea is a good fit for the company at issue. Here, current strengths and weaknesses of the company can be explored to determine how/if the idea complements the business of the company or otherwise offers a competitive edge. Here, existing products, issues, processes, etc. can be evaluated to establish if the innovation would add benefit.

In performing this analysis, an intellectual property protection (e.g., patent) packet can be established and delivered to the appropriate individuals to further evolution and decisioning. This packet can include invention disclosure materials, system drawings, flow diagrams, etc.

Market viability can be evaluated to further determine if the project or innovation would be beneficial to the company. Similarly, a more detailed analysis can be performed. For instance, conceptual architectures can be put formulated to facilitate evaluation of value, cost and ROI to the company.

The fourth phase focuses on the customer—for example, this phases establishes if the innovation ‘prove out’ such that it provides value add to a company thereby establishing a competitive edge. In proving out the innovation, presentations, road shows and the like are utilized to promote the idea. The scope and feature list can be modified throughout this process. Additionally, the short term, medium term and long term timeline proposals can be overlaid in order to ‘prove out’ the idea. Accordingly, as illustrated, at this phase, a decision is made to either launch or shelve the idea.

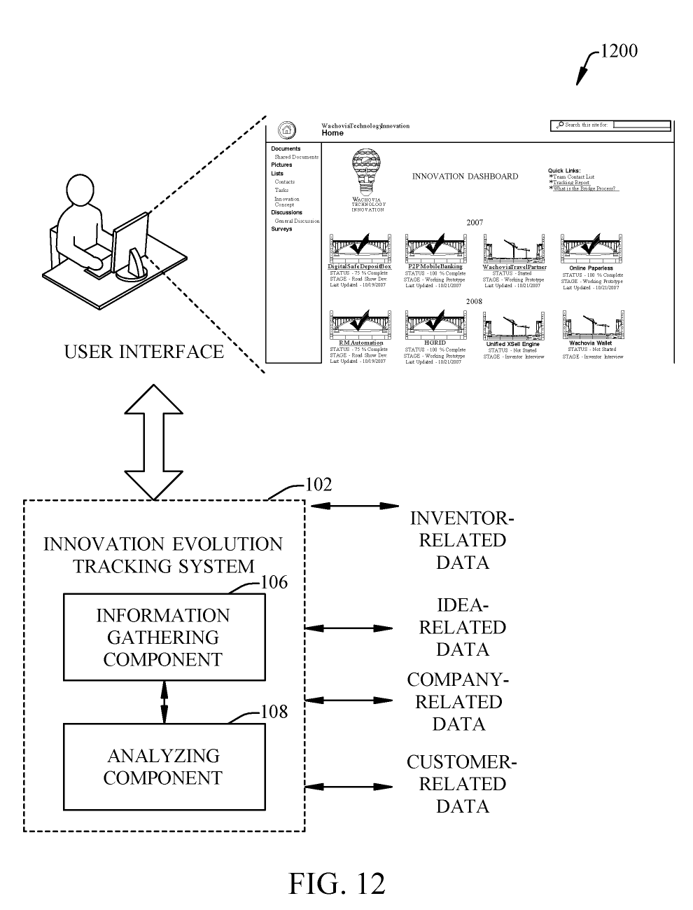

Referring now to FIG. 12, an example system 1200 is illustrated in accordance with an aspect of the innovation. Generally, the system 1200 illustrates that the innovation evolution tracking system 102 can be employed in conjunction with user interfaces (UI) which effect gathering the information related to individual phases of the evolution. As described above, the innovation can present individuals with questions in order to solicit information related to the development of the idea.

Additionally, as shown, the display can employed to render the dashboard as described above. As described above, the dashboard can be used to consolidate and present status of one or more innovations. The dashboard rendering can employ graphical characteristics that enhance glance-ability which enables efficient innovation status. Moreover, the dashboard can be used to facilitate the marketing of the innovation, for example, by highlighting company and/or customer fit.

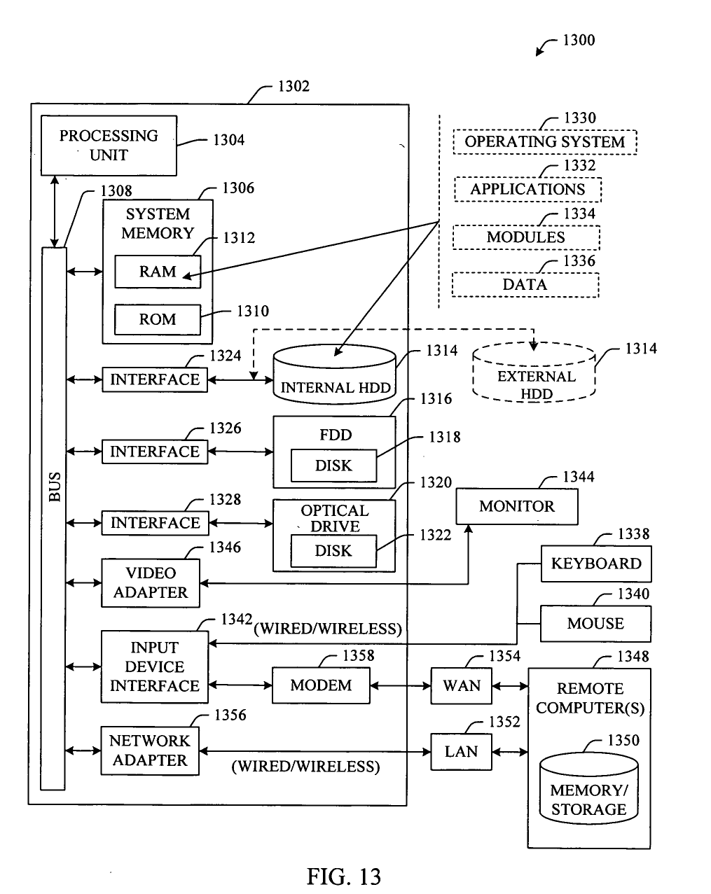

Referring now to FIG. 13, there is illustrated a block diagram of a computer operable to execute the disclosed architecture. In order to provide additional context for various aspects of the subject innovation, FIG. 13 and the following discussion are intended to provide a brief, general description of a suitable computing environment 1300 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the innovation includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

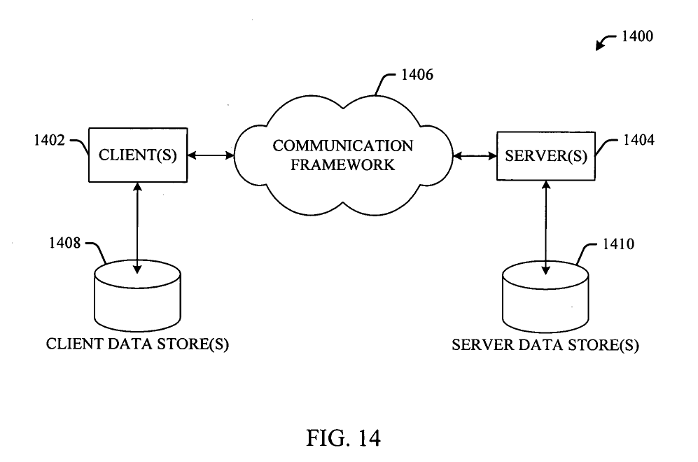

Referring now to FIG. 14, there is illustrated a schematic block diagram of an exemplary computing environment 1400 in accordance with the subject innovation. The system 1400 includes one or more client(s) 1402. The client(s) 1402 can be hardware and/or software (e.g., threads, processes, computing devices). The client(s) 1402 can house cookie(s) and/or associated contextual information by employing the innovation, for example.

The system 1400 also includes one or more server(s) 1404. The server(s) 1404 can also be hardware and/or software (e.g., threads, processes, computing devices). The servers 1404 can house threads to perform transformations by employing the innovation, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates innovation development, comprising:
an information gathering component that employs a series of user interfaces (UIs) to aggregate innovation-related data; and
an analyzer component that evaluates a subset of the innovation-related data, determines one of approval, denial or suspension related to the innovation and graphically conveys the one of approval, denial or suspension to an entity.

2. The system of claim 1, wherein the development is defined by four phases, wherein each of the phases employs four week duration.

3. The system of claim 1, further comprising a dashboard component that graphically conveys status of the innovation to the entity.

4. The system of claim 1, wherein the dashboard employs a rendering of a bridge construction to convey the status, wherein completion of the bridge construction is proportional to the status.

5. The system of claim 1, wherein the innovation-related data includes information that focuses upon an inventor of the innovation.

6. The system of claim 5, wherein the inventor-focused information defines whether the inventor is a willing participant in the innovation and, if so, additional innovation-related information is captured.

7. The system of claim 6, wherein the innovation-related data includes information that focuses upon an idea of the innovation.

8. The system of claim 7, wherein the idea-focused information defines whether the idea is mature and, if so, additional innovation-related information is captured.

9. The system of claim 8, wherein the innovation-related data includes information that focuses on a company.

10. The system of claim 9, wherein the company-related information defines whether the innovation fits into the company's scope and, if so, additional innovation-related information is captured.

11. The system of claim 10, wherein the innovation-related data includes information that focuses on a customer of the company.

12. The system of claim 11, wherein the customer-related information defines whether the innovation ‘proves out’ and, if so, the innovation is passed to deployment.

13. The system of claim 1, further comprising a logic component that employs at least one of rules-based, artificial intelligence (AI) or machine learning & reasoning (MLR) logic to evaluate the subset of the innovation-related data and to determine at least one of approval, denial or suspension of the innovation.

14. The system of claim 1, further comprising an innovation dashboard that conveys status of the innovation together with status of a plurality of other innovations related to an entity.

15. The system of claim 1, further comprising a dashboard component that includes a series of user interfaces which solicit the innovation-related data.

16. The system of claim 1, wherein the analyzer component generates a storyboard of the idea that conveys a near term, medium term and long term evolution of the innovation.

17. A computer-implemented method of managing evolution of an innovation, comprising:
gathering inventor-related data associated with the innovation;
determining, within four weeks, if the sufficient features exist within the innovation;
if sufficient features exist within the innovation, gathering idea-related data associated with the innovation, else suspending the innovation;
if idea-related data is gathered, determining if the innovation is mature;
if the idea is mature, gathering company-related data associated with the innovation, else suspending the innovation;
if company-related data is gathered, determining if the innovation fits within a company scope;
if the idea fits within the company scope, gathering customer-related data associated with the innovation, else suspending the innovation;
if customer-related data is gathered, determining if the innovation proves out; and
if the innovation proves out, deploying the innovation, else suspending the innovation.

18. The computer-implemented method of claim 17, further comprising establishing a storybook of the idea, wherein the storybook facilitates the determination of maturity of the innovation.

19. A computer-executable system of tracking evolution of an innovation, comprising:
means for gathering innovation-related data;
means for analyzing the innovation-related data, wherein the means for analyzing establishes at least one of sufficency of features, maturity of the innovation, fit within a company or affirmation of prove out, as a function of a subset of the innovation-related data.

20. The computer-executable system of claim 19, means for graphically conveying status of the innovation based upon the analysis, wherein the status is conveyed as a function of bridge construction.
